(19) United States
(12) Patent Application Publication
(10) Pub. No.: US 2026/0089338 A1
(43) Pub. Date: Mar. 26, 2026

(54) METHOD AND APPARATUS FOR ENHANCED SIGNALING FOR BLOCK PARTITION SYNTAX

(71) Applicant: Tencent America LLC, Palo Alto, CA (US)

(72) Inventors: Tianqi LIU, Palo Alto, CA (US); Liang ZHAO, Palo Alto, CA (US); Madhu PERINGASSERY KRISHNAN, Palo Alto, CA (US); Shan LIU, Palo Alto, CA (US)

(21) Appl. No.: 19/207,250

(22) Filed: May 13, 2025

Related U.S. Application Data
(60) Provisional application No. 63/699,694, filed on Sep. 26, 2024.

(51) Int. Cl. H04N 19/176; H04N 19/119; H04N 19/196; H04N 19/70; H04N 19/91

(52) U.S. Cl. CPC H04N 19/176; H04N 19/119; H04N 19/196; H04N 19/70; H04N 19/91

(57) ABSTRACT

An example method of video coding includes receiving a video bitstream including a plurality of coding blocks and a set of syntax elements related to block partitioning. The method includes, when a shape of the current block is a first shape, entropy decoding the set of syntax elements using a first context; and when the shape of the current block is a second shape, different than the first shape, entropy decoding the set of syntax elements using a second context, different than the first context, and partitioning the current block according to the set of syntax elements.

### RELATED APPLICATIONS

This application claims priority to U.S. Provisional Patent Application No. 63/699,694, entitled “Method and Apparatus for Enhanced Signaling for Block Partition Syntax,” filed Sep. 26, 2024, which is hereby incorporated by reference in its entirety.

### TECHNICAL FIELD

The disclosed embodiments relate generally to video coding, including but not limited to systems and methods for entropy coding of signaled syntax.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates.

### SUMMARY

The present disclosure describes amongst other things, a set of methods for video (image) compression, more specifically related to block partitioning and coding of signaled syntax elements based on a shape of the current block. Some embodiments include using coded information (e.g., relating to the current block and/or neighboring blocks) as a context for a probability model used to entropy encode one or more signaled flags. Using coded information, such as a shape of the current block, as context may reduce hardware buffer requirements, e.g., by grouping multiple different sizes of the current block having the same shape into a single index, as compared to implementations in which every size of the current block has its own index. By taking into account a height/width ratio of the current block, coding loss may be reduced even while grouping blocks of different sizes. Coding accuracy may also be improved by taking into account the partitioning context of neighboring blocks.

In accordance with some embodiments, a method of video decoding includes (i) receiving a video bitstream (e.g., a coded video sequence) comprising a plurality of blocks including a current block, and a set of syntax elements related to block partitioning; (ii) when a shape of the current block is a first shape, entropy decoding the set of syntax elements using a first context; (iii) when the shape of the current block is a second shape, different than the first shape, entropy decoding the set of syntax elements using a second context, different than the first context; and (iv) partitioning the current block according to the set of syntax elements.

In accordance with some embodiments, a method of video encoding includes (i) receiving video data (e.g., a source video sequence) comprising a plurality of blocks that includes a current block; (ii) partitioning the current block according to a set of block partitioning parameters; (iii) generating a set of entropy-encoded syntax elements by: (a) when a shape of the current block is a first shape, entropy encoding the set of block partitioning parameters using a first context; and (b) when the shape of the current block is a second shape, different than the first shape, entropy encoding the set of block partitioning parameters using a second context, different than the first context; (iv) signaling the set of entropy-encoded syntax elements in a video bitstream.

In accordance with some embodiments, a method of processing visual media data includes (i) obtaining a source video sequence that comprises a plurality of frames; and (ii) performing a conversion between the source video sequence and a video bitstream of visual media data according to a format rule, where the video bitstream comprises a plurality of encoded blocks including a current block, and a set of syntax elements related to block partitioning; and where the format rule specifies that: (a) when a shape of the current block is a first shape, the set of syntax elements is to be entropy decoded using a first context; (b) when the shape of the current block is a second shape, different than the first shape, the set of syntax elements is to be entropy decoded using a second context, different than the first context; and (c) the current block is to be partitioned according to the set of syntax elements.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder). In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIGS. 4A, 4B, and 4C illustrate examples of partitioning of coding blocks in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques including entropy coding a set of syntax elements using a first context or a second context, different than the first context; based on a shape on a current block and partitioning the current block based on the set of syntax elements. Advantages of using entropy coding that takes into a shape of the current block include reducing a hardware buffer requirement by grouping multiple different sizes of the current block having the same shape into a single index compared to an implementation in which every size of the current block has its own index. By considering a height/width ratio of the current block in determining the grouped index, coding loss may be reduced. Coding accuracy may also be improved by considering the partitioning context of neighboring blocks.

### Example Systems and Devices

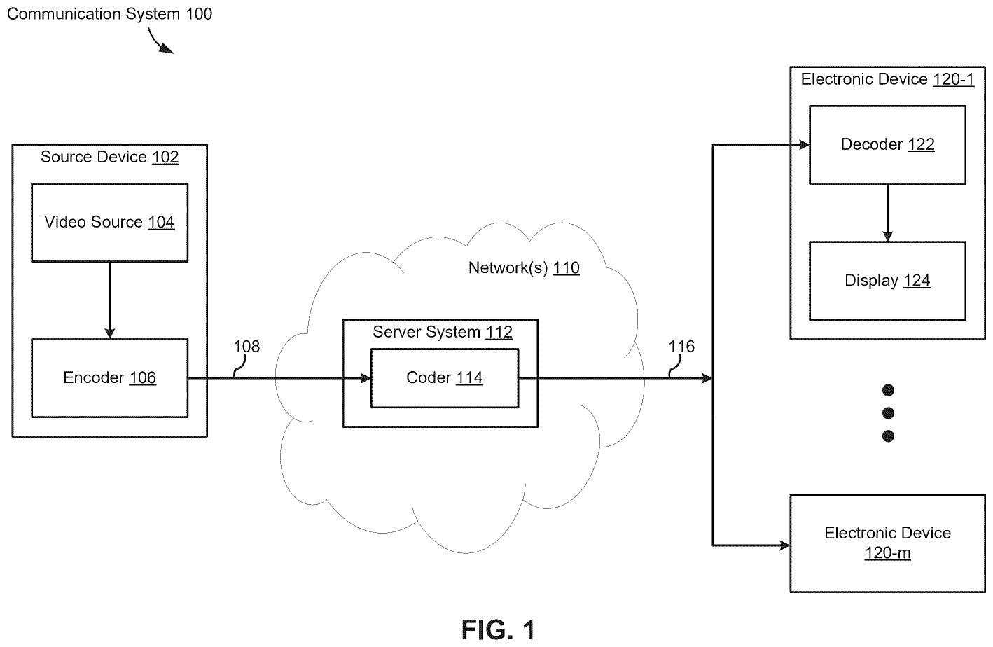

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

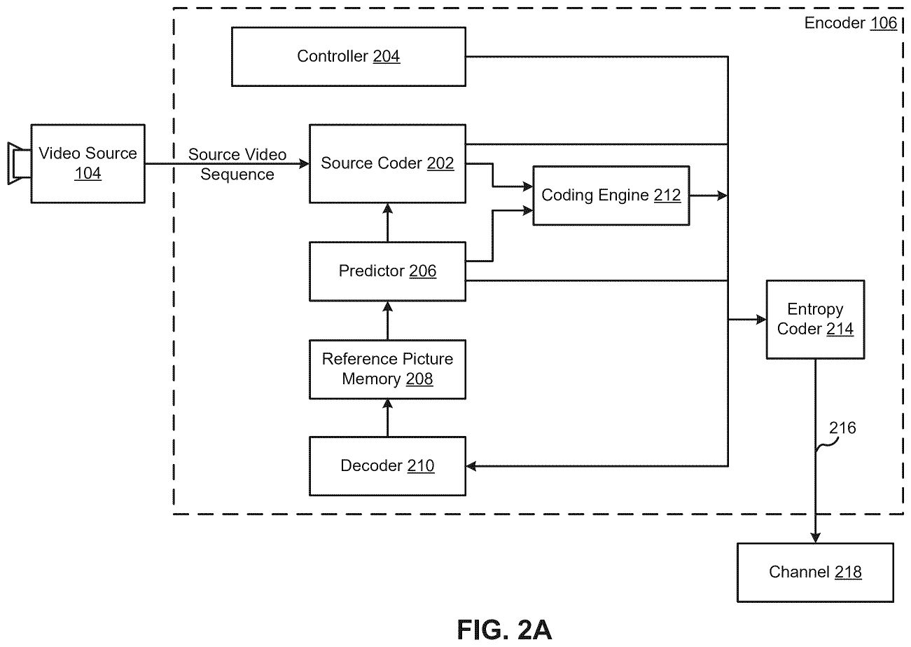

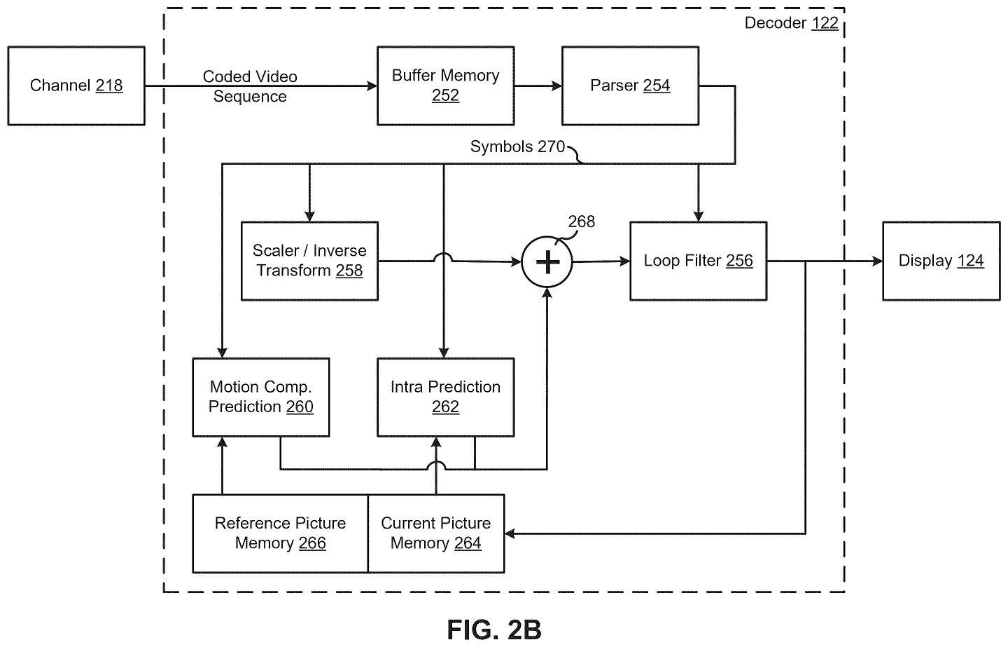

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh

(IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

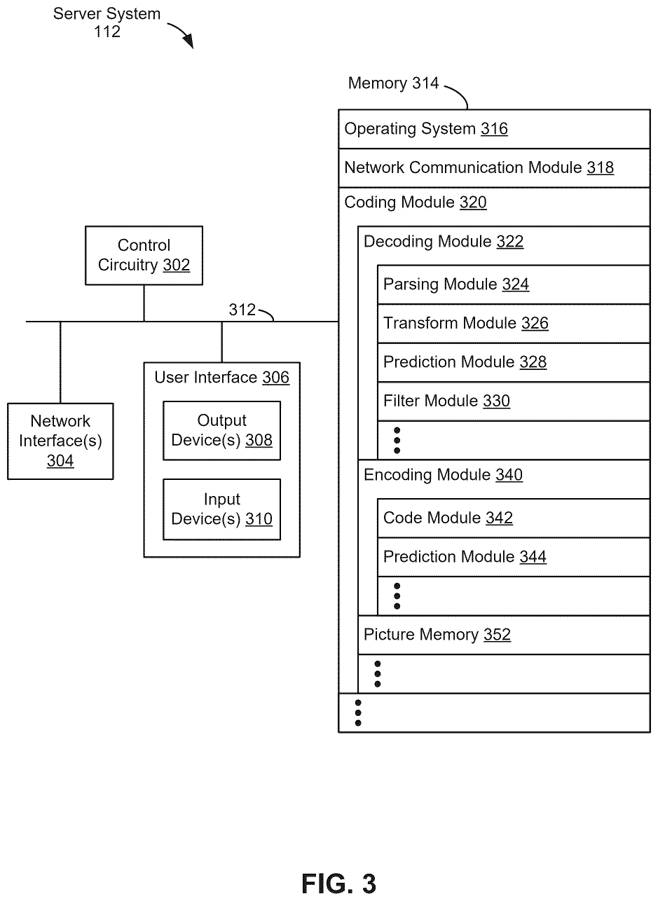

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). As used herein, the term “block” may refer to a coding block (such as super block, or largest coding unit, or coding tree block), a prediction block, a transform block, or a filtering unit. Additionally, a “subblock” of a block A refers to a block whose area is fully contained in the block A. Block shape can be referred to as a block width to height ratio, block area size, whether a block is a square block, a tall block or a flat block, and the like.

As used herein, the term “block region” refers to a specific block area which contains one or more blocks. A block size group may be a collection of multiple block sizes. For example, multiple block sizes that are similar to each other (e.g., in terms of number of samples, or difference between width and/or height) may be assigned as a block size group. Thus, blocks of multiple sizes may belong to a single group.

As described previously, general partitioning may start from a base block (e.g., a superblock or root node) and may follow a predefined ruleset, partition structure, and/or scheme. The partitioning may be hierarchical and/or recursive. After dividing or partitioning a base block using any of the example partitioning procedures or other procedures described herein, or the combination thereof, a final set of partitions or coding blocks may be obtained. Each of these partitions may be at one of various partitioning levels in the partitioning hierarchy, and may be of various shapes. Each of the partitions may be referred to as a coding block (CB), such partitions are referred to as coding blocks because they may form units for which some basic coding/decoding decisions may be made and coding/decoding parameters may be optimized, determined, and signaled in an encoded video bitstream. The highest or deepest level in the final partitions represents the depth of the coding block partitioning structure of tree. A coding block may be a luma coding block or a chroma coding block. The hierarchical structure of for all color channels may be collectively referred to as coding tree unit (CTU). The partitioning patterns or structures for the various color channels in a CTU may or may not be the same.

In some embodiments, either intra coding or inter-coding is allowed in different portions of a particular coding region of a frame. In particular, a portion or an entirety of a region of a frame or picture or slice at various partitioning levels (e.g., various recursive partitioning levels) may be coded in inter prediction mode, intra prediction mode, and/or other prediction modes (e.g., inter-intra prediction).

A region, or coding region, may be used to refer to any level in any one of the partitioning schemes described above or in other partitioning schemes not specifically described above. A region therefore may be a frame, a slice, a super block, a macroblock, a subblock, a prediction block, and the like. For example, a region may be any partitioning level of a recursive partitioning scheme.

In some embodiments, when splitting a region into one or multiple sub-regions, at least one flag or syntax element is included in the bitstream by an encoder (and subsequently received, parsed, and decoded by a decoder) to indicate whether all the child regions in the region are all coded with a pre-defined prediction mode. Such a flag may be referred to as a region type flag or a regional prediction mode flag syntax element at various regional signaling levels. The partitioning scheme, for example, may be a recursive partitioning scheme, and at least one such flag may be included in the bitstream by an encoder to indicate whether all child regions within this region are coded with the pre-defined prediction mode.

When the decoder parses the bitstream and determines that the parsed syntax associated with such a flag for the region indicates that coded lower-level/child regions within the region can use different prediction modes, then decoder may expect additional lower-level regional prediction mode flag(s)/indicators (optionally at each of the corresponding partitioning level within the coding region) in the bitstream corresponding to lower-level/child regions of this region for indicating whether each of the child regions are coded under a predefined prediction mode (e.g., under an intra prediction mode, an inter prediction mode, or an intra-inter prediction mode). In some embodiments, a region type flag may not be included in the bitstream and thus is not received at the decoder side when the block partitioning mode syntax indicates current region is not further split (e.g., the current region is a leaf level partition). In some embodiments, a high level syntax may be included in the bitstream by the encoder and received at the decoder side to indicate whether the indication for the predetermined prediction mode can be applied to current sequence, frame, slice, super block. Thus, whether the scheme above is used at and below a particular partition level may be enabled or disabled.

When compressing a video frame, a block-based video codec divides the pixels in the frame into multiple rectangular regions called blocks, where different compression strategies can be applied to each block. The pixel area may be partitioned into blocks recursively. At each level of partitioning, a flag may be signaled to indicate whether the current area should be further divided. When no further division is needed, a block may be formed in the current area. When further splits are required, a split type may be signaled to specify how the current area will be subdivided into smaller regions. This process may continue recursively. In some video coding standards, each possible partition split type is predefined. The most fundamental partition type is a square split, where a square can be divided into four equal square blocks. Some video coding standards also allow rectangular partitions with a 1:2 or 2:1 block ratio, and even 1:4, 4:1, 1:8, or 8:1 rectangular blocks are possible. Additionally, there are other partition types, such as H-shaped partitions and uneven four-way partitions, among others.

Signaling or parsing the partition mode or partition type may include context coding the partition mode or partition type using binary or multi-symbol arithmetic coding to enhance coding performance. The context may include factors such as the plane or channel type, block size, and the partition mode.

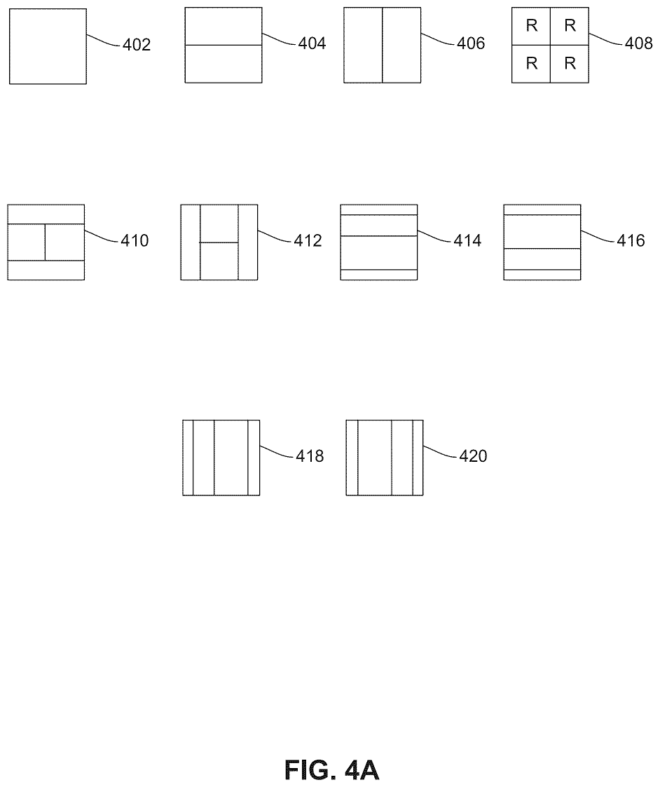

FIG. 4A shows various partition types and partitioning structures in accordance with some embodiments. The root block may start at a predefined level (e.g., from a base block at 128×128 or 64×64 level). As an example, block 402 is not further partitioned, block 404 is split into two equal horizontal partitions, and block 406 is split into two equal vertical partitions. Block 408 is an example of a square split where a square is divided into four equal square blocks. Blocks 410 and 412 are H-partitions, with the block 410 being split into horizontal H partitions (“PARTITION_HORZ_H”), and the block 412 being split into vertical H partitions (“PARTITION_VERT_H”). FIG. 4A also shows partition types that include partitions from an uneven 4-way split/partitioning scheme that may be implemented horizontally, as shown in blocks 414 (“PARTITION_HORZ_4A”) and 416 (“PARTITION_HORZ_4B”), or vertically, as shown in blocks 418 (“PARTITION_VERT_4A”) and 420 (“PARTITION_HORZ_4B”). In particular, partition 414 is horizontally split into 1:2:4:1 regions. Block 416 is horizontally split into 1:4:2:1 regions. Block 418 is vertically split with 1:2:4:1 regions. Block 420 is vertically split with 1:4:2:1 regions.

In some embodiments, related syntax elements for partition signaling may include one or more of: ‘do_split,’ ‘do_square_split’, ‘rect_type,’ ‘do_ext_partition,’ ‘do_uneven_4way_partition,’ and ‘uneven_4way_partition_type’. In some embodiments, “do_split” indicates whether the current block will be further partitioned/split, and the block 402 will have a syntax element “do_split” indicating that the block will not be further split. In some embodiments, “do_square_split” represents whether the current block will be split into 4 same square blocks (e.g., the partitions shown for block 408). In some embodiments, “rect_type” indicates whether the current partition mode is horizontal or vertical mode (e.g., the partitions shown for block 404 and 406). In some embodiments, “do_ext_parititon” indicates whether the current partition mode belongs to the extension partition modes, which includes the H shape partition (e.g., the partitions shown in the block 410 and the block 412) and uneven 4 way partition (e.g., the partitions shown in blocks 414, 416, 418, and 420). In some embodiments, “do_uneven_4way_partition” indicates whether the current partition mode is uneven 4 way (e.g., the partitions shown in blocks 414, 416, 418, and 420). In some embodiments, “uneven_4way_partiiton_type” means the type of uneven 4 way of partition (e.g., “PARTITION_HORZ_4A”, “PARTITION_HORZ_4B”, “PARTITION_VERT_4A”, and “PARTITION_HORZ_4B”).

In some embodiments, these partition-related syntax elements are context-signaled. For example, the flags such as “do_split”, “do_ext_partition”, “do_uneven_4way_partition”, and “uneven_4way_partition_type” have two-dimension contexts: the luma or chroma channels, and the current block size in relation to the partition context of neighboring blocks (top and left). An example block size context (bsize_{ctx}) derivation is shown in Table 1.

TABLE 1
Example Context Index Table

| CTX Index | Shape |
|---|---|
| 0 | 4 × 4, 4 × 8, 8 × 4, 8 × 8 |
| 1 | 8 × 16, 16 × 8, 16 × 16, |
| 2 | 32 × 16, 16 × 32, 32 × 32 |
| 3 | 32 × 64, 64 × 32, 64 × 64 |
| 4 | 64 × 128 |
| 5 | 128 × 64 |
| 6 | 128 × 128 |
| 7 | 128 × 256 |
| 8 | 256 × 128 |
| 9 | 256 × 256 |
| 10 | 4 × 16 |
| 11 | 16 × 4 |
| 12 | 8 × 32 |
| 13 | 32 × 8 |
| 14 | 16 × 64 |
| 15 | 64 × 16 |

In some embodiments, the contexts for “do_square_split” are grouped and determined by two dimensions, the first dimension indicates whether it is the luma or chroma channel, the second dimension indicates whether the block size is the largest superblock size or not.

In some embodiments, the “rect_type” has two dimensions for the context, the first dimension indicates whether it is the luma or chroma channel. The second dimension context includes all the block sizes and the block sizes are not grouped.

In some embodiments, the blocks sizes of neighboring blocks are also used to derive the context. For example, one condition (above_{ctx}) is whether the width of above partition block is equal or larger than the current block width, another condition (left_{ctx}) is whether the height of left partition block is equal or larger than the current block height. The final context is derived as ctx=(above_{ctx}+2×left_{ctx})+bsize_{ctx}.

Example signaling of syntax elements is shown below in Table 1B.

TABLE 1B
Example Syntax

| | |
|---|---|
| do_split_flag | ae(v) |
| If (!do_split_flag) | |
| return. | |
| do_square_split_flag | ae(v) |
| If (do_square_split_flag) | |
| return. | |
| rect_partition_flag | ae(v) |
| do_ext_partition_flag | ae(v) |
| If (do_ext_partition_flag){ | |
| do_uneven_4way_partition_flag | ae(v) |
| If (do_uneven_4way_partition_flag) { | |
| uneven_4way_type_flag | ae(v) |
| } | |
| } | |

In some embodiments, the shape of the current block is employed to derive the context for the partition mode related syntaxes of the current block. In other words, blocks having the same shape may share the context even though the blocks of the same shape do not have the same block size. Block shape can refer to a block width to height ratio, a block area size, whether a block is a square block, a tall block or a flat block, or the like.

In some embodiments, a ratio R of block width to block height is used as the context when signaling or parsing partition mode related syntaxes (e.g., “rect_type” which indicates a rectangle partition mode such as the blocks 404 and 406). In some embodiments, the context index derivation takes into consideration both the block shape ratio R and the block size. In some embodiments, the ratio R can be 1:1, 1:2, 1:4, . . . , 1:N, and 2:1, 4:1, . . . , N:1, and the like. For example, when signaling or parsing partition mode-related syntax elements, such as “rect_type”, the ratio of block width to block height and the block size may be used together to derive the context. As shown in the Table 2, block shapes may be used to derive the context, for the ratio R as 1:1, the block size 8×8, 16×16, 32×32, 64×64 can be grouped together (e.g., CTX index of 0). For the ratio R as 1:2, the block shape 8×16, 16×32, 32×64, and 64×128 can be grouped together (e.g., CTX index of 1). For the ratio R as 2:1, the block shape 16×8, 32×16, 64×32, and 128×64 can be grouped together (e.g., CTX index of 2). For the ratio R as 1:4, the block shape 8×32 and 16×64 can be grouped together (e.g., CTX index of 3). For the ratio R as 4:1, the block shape 32×8 and 64×16 can be grouped together (e.g., CTX index of 4). Other block shapes of larger sizes have their own context based on their block sizes (e.g., CTX index of 5 for a square block of size 128×128, and CTX index of 8 for a square block of size 256×256).

TABLE 2
Example Context Index Derivation Table

| CTX Index | Shape |
|---|---|
| 0 | 8 × 8, 16 × 16, 32 × 32, 64 × 64 |
| 1 | 8 × 16, 16 × 32, 32 × 64, 64 × 128 |
| 2 | 16 × 8, 32 × 16, 64 × 32, 128 × 64 |
| 3 | 8 × 32, 16 × 64 |
| 4 | 32 × 8, 64 × 16 |
| 5 | 128 × 128 |
| 6 | 128 × 256 |
| 7 | 256 × 128 |
| 8 | 256 × 256 |

In some embodiments, instead of the context index derivation table shown in Table 2, another context index derivation table that uses both the ratio R of block width to block height and the block size to derive the context may be provided. As shown in the Table 3, block shape may be used to derive the context. For the ratio R of 1:1, the block size 8×8, and 16×16 can be grouped together (e.g., CTX index of 0). For the ratio R of 1:2, the block shape 8×16 and 16×32 can be grouped together (e.g., CTX index of 1). For the ratio R of 2:1, the block shape 16×8 and 32×16 can be grouped together (e.g., CTX index of 2). For the ratio R of 1:4, the block shape 8×32 and 16×64 can be grouped together (e.g., CTX index of 13). For the ratio R of 4:1, the block shape 32×8 and 64×16 can be grouped together (e.g., CTX index of 14). Other block shapes of larger sizes have their own context based on their block sizes (e.g., CTX index of 6 for a square block of size 64×64, and CTX index of 9 for a square block of size 128×128). In some embodiments, hardware may limit the buffer size available for storing the information relating to the context index and size/shape mapping. Grouping of blocks having the same shape but are of different sizes may help to lower buffer requirements. In some embodiments, the mapping illustrated in Table 3 may be used instead of the mapping illustrated in Table 1 when there is a lower buffer budget allocated. Efficiently grouping blocks of different sizes into appropriate groups may help to reduce coding losses attributed to not assigning a respective context index to blocks of every size.

TABLE 3
Example Context Index Derivation Table

| CTX Index | Shape |
|---|---|
| 0 | 8 × 8, 16 × 16 |
| 1 | 8 × 16, 16 × 32 |
| 2 | 16 × 8, 32 × 16 |
| 3 | 32 × 32 |
| 4 | 32 × 64 |
| 5 | 64 × 32 |
| 6 | 64 × 64 |
| 7 | 64 × 128 |
| 8 | 128 × 64 |
| 9 | 128 × 128 |
| 10 | 128 × 256 |
| 11 | 256 × 128 |
| 12 | 256 × 256 |
| 13 | 8 × 32, 16 × 64 |
| 14 | 32 × 8, 64 × 16 |

In some embodiments, instead of the context index derivation table shown in Tables 2 and 3, another context index derivation table that uses both the ratio R of block width to block height and the block size to derive the context may be provided. As shown in the Table 4, block shape may be used to derive the context. For the ratio R of 1:1, the block size 8×8, 16×16, and 32×32 can be grouped together (e.g., CTX index of 0). For the ratio R of 1:2, the block shape 8×16, 16×32, and 32×64 can be grouped together (e.g., CTX index of 1). For the ratio R of 2:1, the block shape 16×8, 32×16, and 64×32 can be grouped together (e.g., CTX index of 2). For the ratio R of 1:4, the block shape 8×32 and 16×64 can be grouped together (e.g., CTX index of 10). For the ratio R of 4:1, the block shape 32×8 and 64×16 can be grouped together (e.g., CTX index of 11). Other block shapes of larger sizes have their own context based on their block sizes (e.g., CTX index of 6 for a square block of size 128×128, and CTX index of 9 for a square block of size 256×256), as shown in Table 4 below.

TABLE 4
Example Context Index Derivation Table

| CTX Index | Shape |
|---|---|
| 0 | 8 × 8, 16 × 16, 32 × 32 |
| 1 | 8 × 16, 16 × 32, 32 × 64 |
| 2 | 16 × 8, 32 × 16, 64 × 32 |
| 3 | 64 × 64 |
| 4 | 64 × 128 |
| 5 | 128 × 64 |
| 6 | 128 × 128 |
| 7 | 128 × 256 |
| 8 | 125 × 128 |
| 9 | 256 × 256 |
| 10 | 8 × 32, 16 × 64 |
| 11 | 32 × 8, 64 × 16 |

In some embodiments, for square blocks, each different blocks size may have a different context. In contrast, the contexts may be grouped together for non-square (e.g., rectangular) blocks, based on block size and block ratio R. In other words, the context index derivation may consider both the block shape ratio R and the block size, as shown in Table 5 below.

TABLE 5
Example Context Index Derivation Table

| CTX Index | Shape |
|---|---|
| 0 | 8 × 8 |
| 1 | 16 × 16 |
| 2 | 32 × 32 |
| 3 | 64 × 64 |
| 4 | 128 × 128 |
| 5 | 256 × 256 |
| 6 | 8 × 16, 16 × 32, 32 × 64 |
| 7 | 16 × 8, 32 × 16, 64 × 32 |
| 8 | 128 × 64 |
| 9 | 64 × 128 |
| 10 | 128 × 256 |
| 11 | 256 × 128 |
| 12 | 8 × 32, 16 × 64 |
| 13 | 32 × 8, 64 × 16 |

In some embodiments, the derivation of the block shape context includes considering the partition context of the neighboring blocks (e.g., left and/or top blocks) blocks' partition context, such as:

$$ctx = ( {above}_{ctx} + 2 \times {left}_{ctx} ) + {bshape}_{ctx} * offset \qquad Equation ( 1 )$$

In some embodiments, the offset may be 4, and the bshape_{ctx} may be determined (e.g., from the CTX index, based on the shape of the block) from one or more of Tables 1-5, or another table. Applying the offset and using the above_{ctx} (e.g., a value of either 1 or 0) and left_{ctx} (e.g., a value of either 1 or 0) allows the above and left context to fill in for values of the context (e.g., ctx) at values between the increment offered by the offset.

In some embodiments, the ratio R of block width to height is combined with other factors to form the context for signaling, parsing and deriving the partition mode related syntax. The block size and block shape ratio can be combined with any other information in the coding process, such as the plane type (e.g., luma or chroma), prediction type (e.g., intra or inter), and previous partition mode to determine the context of the current partition mode.

In some embodiments, the block shape of the neighboring blocks is used to derive the context for signaling the block partition related context of current block.

In some embodiments, the plane type (e.g., luma or chroma) serves as the first dimension for the context derivation, and the block shape serves as the second dimension. For example, for the ratio R of 1:1, the block sizes 8×8 and 16×16 are grouped together. For the ratio R of 1:2, the block sizes 8×16 and 16×32 are grouped together. For the ratio R of 2:1, the block sizes 16×8 and 32×16 are grouped together. For the ratio R of 1:4, the block sizes 4×16, 8×32 and 16×64 can be grouped together. For the ratio R of 4:1, the block sizes 16×4, 32×8 and 64×16 can be grouped together. Other block shapes with large block sizes have their own block shape as the context.

In some embodiments, the first dimension is the plane type (e.g., luma or chroma), while the second dimension is the block shape, in relation to the partition context of neighboring blocks (e.g., top and/or left).

$${ctx}_{2 nd} = ( {above}_{ctx} + 2 \times {left}_{ctx} ) + {bshape}_{ctx} * offset \qquad Equation ( 2 )$$

In some embodiments, the offset is 4. Applying the offset and using the above_{ctx} (e.g., a value of either 1 or 0) and left_{ctx} (e.g., a value of either 1 or 0) allows the above and left context to fill in for values of the context (e.g., ctx_{2nd}) at values between the increment offered by the offset.

In some embodiments, when the current block has a rectangular shape and the block width to height (or height to width) ratio N (e.g., similar to ratio R) exceeds or equal to a certain threshold T, the allowed partition split types at this partition point is a subset of the full partition modes. The subset of subsequent partition can be any combination of none partition (e.g., the block 402), vertical partition (e.g., the block 406), horizontal partition (e.g., the block 404), H shape partition (e.g., the blocks 410 and 412), and uneven 4-way partition (e.g., the blocks 414, 416, 418, and 420), and the like. In some embodiments, two syntax elements indicate the partition subset index (e.g., a 1-bit flag such as sub_partition_set_flag) and the partition type index (e.g., sub_partition_type_flag that may have more bits) within the partition subset. In some embodiments, T is set to 4. Table 6 below illustrates an example syntax table for the described two syntax elements.

TABLE 6
Example Syntax

| | |
|---|---|
| do_split_flag | ae(v) |
| If (!do_split_flag) | |
| return. | |
| do_square_split_flag | ae(v) |
| If (do_square_split_flag) | |
| return. | |
| if (N > T) { | |
| sub_partition_set_flag | ae(v) |
| sub_partition_type_flag | ae(v) |
| } | |
| else { | |
| rect_partition_flag | ae(v) |
| do_ext_partition_flag | ae(v) |
| If (do_ext_partition_flag){ | |
| do_uneven_4way_partition_flag | ae(v) |
| If (do_uneven_4way_partition_flag) { | |
| uneven_4way_type_flag | ae(v) |
| } | |
| } | |
| } | |

In some embodiments, for a current block having a rectangular shape, and N that exceeds a threshold, the subsequent partition set flag may be implicitly derived such that only the partition type index (e.g., sub_partition_type_flag) is signaled. Table 7 below illustrates an example syntax table in which the partition set flag is implicitly derived.

TABLE 7
Example Syntax

| | |
|---|---|
| do_split_flag | ae(v) arithemtic |
| | or entropy coding |
| If (!do_split_flag) | |
| return. | |
| do_square_split_flag | ae(v) |
| If (do_square_split_flag) | |
| return. | |
| if (N > T) { | |
| sub_partition_type_flag | ae(v) |
| } | |
| else { | |
| rect_partition_flag | ae(v) |
| do_ext_partition_flag | ae(v) |
| If (do_ext_partition_flag){ | |
| do_uneven_4way_partition_flag | ae(v) |
| If (do_uneven_4way_partition_flag) { | |
| uneven_4way_type_flag | ae(v) |
| } | |
| } | |
| } | |

In some embodiments, when N exceeds the threshold, the subset size of the allowed partition split types at this partition point may be 1 and the subsequent partition may be restricted to 1:k*N or k*N:1 for a current block shape of 1:N or N:1, respectively, as shown in FIG. 4B. In such embodiments, a flag (e.g., a 1-bit sub_partition_flag) is used to indicate the following partition, and the partition mode can be implicitly derived without signaling. Table 8 below illustrates an example syntax table in which the partition set flag is implicitly derived and the subset size is 1.

TABLE 8
Example Syntax

| | |
|---|---|
| do_split_flag | ae(v) |
| If (!do_split_flag) | |
| return. | |
| do_square_split_flag | ae(v) |
| If (do_square_split_flag) | |
| return. | |
| if (N > T) { | |
| sub_partition_flag | ae(v) |
| } | |
| else { | |
| rect_partition_flag | ae(v) |
| do_ext_partition_flag | ae(v) |
| If (do_ext_partition_flag){ | |
| do_uneven_4way_partition_flag | ae(v) |
| If (do_uneven_4way_partition_flag) { | |
| uneven_4way_type_flag | ae(v) |
| } | |
| } | |
| } | |

FIG. 4B illustrates an example of a K*N: L horizontal partition in accordance with some embodiments. A block 422 has a width of K*N and a height of K is partitioned into K horizontal partitions each having a height of 1 and a width of K*N. In some embodiments, when N exceeds the threshold, the subsequent partition is restricted to 1:2N or 2N:1 for a current block shape of 1:N or N:1, respectively, without the need for an explicit flag to indicate its partition mode in the bitstream. In some embodiments, only a flag (sub_partition_flag) is used to indicate whether the current block is split or not is required for signaling, parsing, or deriving processes.

In some embodiments, when N exceeds the threshold, the subset size of the allowed partition split types at this partition point may be 1 and the subsequent partition block size is limited to 1:N/k or N/k:1 for a current block shape of 1:N or N:1, respectively, as shown in FIG. 4C. In such scenarios, only a flag may be used to indicate that the current block is partitioned and the partition mode can be implicitly derived without signaling. FIG. 4B illustrates an example of a N:1 shaped current block that is vertically partitioned in accordance with some embodiments. A block 430 has a width of N and a height of 1 is partitioned into K vertical partitions each having a height of 1 and a width of N/K.

In some embodiments, when N exceeds the threshold, the subsequent partition block size is limited to 1:N/2 or N/2:1 for a current block shape of 1:N or N:1, respectively, without the use of an explicit flag to indicate its partition mode. In some embodiments, only a flag to indicate whether the current block is split or not is used for the signaling, parsing, or deriving processes. In some embodiments, when N exceeds the threshold, the subset size may be 1 and the subsequent partition block types may be limited to vert_H (e.g., the block 412) and horz_H (e.g., the block 410) for a current block shape of 1:N or N:1, respectively, or vice versa. In some embodiments, when N exceeds the threshold, the subset size of the allowed partition split types at this partition point may be 2 and the subsequent partition block shape is limited to [vert_uneven_4way_A, vert_uneven_4way_B] (e.g., the block 418, and the block 420) and [hort_uneven_4way_A, hort_uneven_4way_B] (e.g., the block 414, and the block 416) for a current block shape of 1:N or N:1, respectively, or vice versa.

A correlation between the partition context of neighboring blocks (e.g., top and/or left) and the partition context of the current block may help to achieve better entropy coding efficiency.

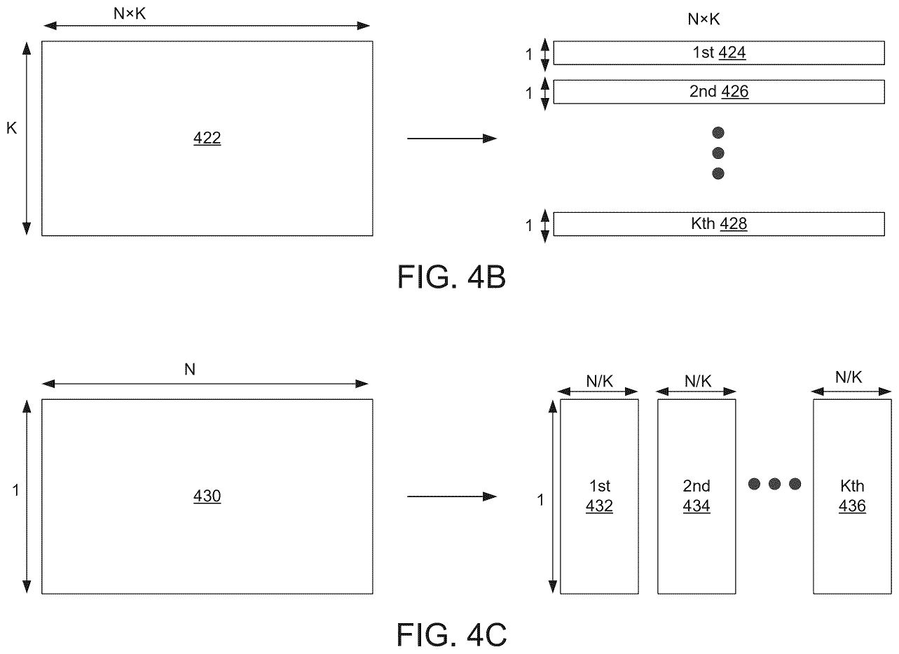

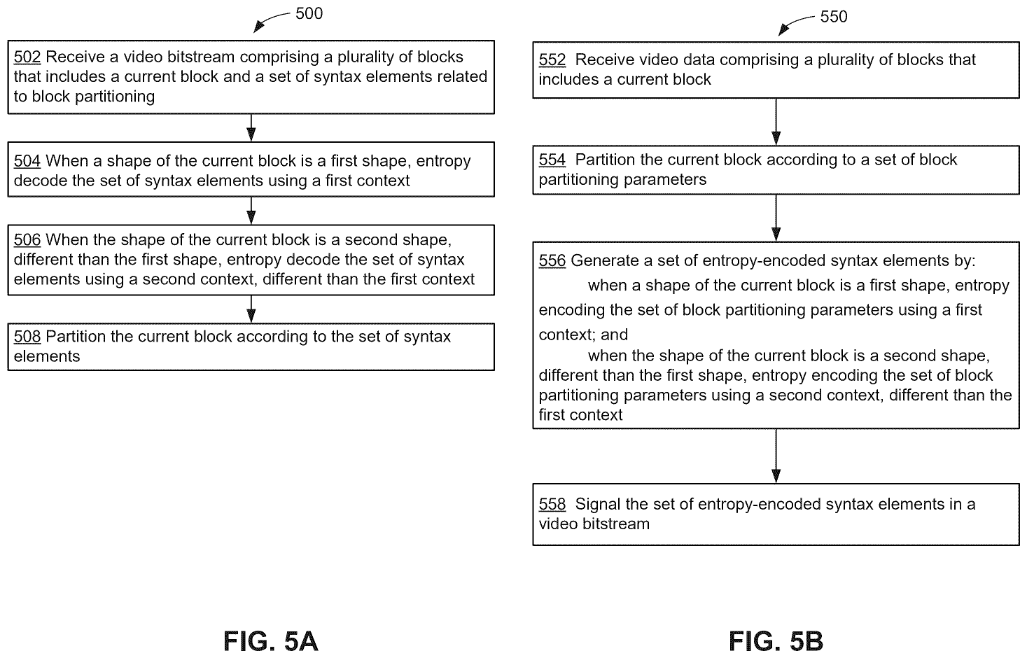

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) video bitstream (e.g., a coded video sequence) comprising a plurality of blocks (e.g., corresponding to a set of pictures) including a current block, and a set of syntax elements related to block partitioning. When a shape of the current block is a first shape, the system entropy decodes (504) the set of syntax elements using a first context. When the shape of the current block is a second shape, different than the first shape, the system entropy decodes (506) the set of syntax elements using a second context, different than the first context. The system partitions (508) the current block according to the set of syntax elements. In this way, a shape of the current block may be employed to derive the context for partition mode related syntaxes of the current block. Blocks that have the same shape may share a context even though they do not have the same block size.

In some embodiments, a ratio R of block width to block height is used as the context when signaling or parsing partition mode related syntaxes. The context index derivation may consider the block shape ratio R and also the block size. The related syntax elements may include ‘rect_type’, which indicates a rectangle partition mode.

In some embodiments, the ratio R can be 1:1, 1:2, 1:4, . . . , 1:N, and 2:1, 4:1, . . . , N:1, and the like. In some examples, when signaling or parsing these partition mode-related syntax elements, e.g., the “rect_type”, the ratio of block width to block height and the block size may be used together to derive the context. As shown in Table 2, block shape may be used to derive the context. For the ratio R of 1:1, block sizes 8×8, 16×16, 32×32, 64×64 can be grouped together. For the ratio R of 1:2, block shapes 8×16, 16×32, 32×64, and 64×128 can be grouped together. For the ratio R of 2:1, block shapes 16×8, 32×16, 64×32, and 128×64 can be grouped together. For the ratio R of 1:4, block shapes 8×32 and 16×64 can be grouped together. For the ratio R of 4:1, block shapes 32×8 and 64×16 can be grouped together. Other block shape with larger sizes use their own block size as the context.

In some embodiments, when signaling or parsing these partition mode-related syntax elements, e.g., the “rect_type”, the ratio of block width to block height, and the block size may be used together to derive the context. As shown in the Table 3, block shape may be used to derive the context. For the ratio R of 1:1, block sizes 8×8, and 16×16 can be grouped together. For the ratio R of 1:2, block shapes 8×16 and 16×32 can be grouped together. For the ratio R of 2:1, block shapes 16×8 and 32×16 can be grouped together. For the ratio R of 1:4, block shapes 8×32 and 16×64 can be grouped together. For the ratio R of 4:1, block shapes 32×8 and 64×16 can be grouped together. Other block shapes with larger sizes use their own block size as the context.

In some embodiments, when signaling or parsing these partition mode-related syntax elements, e.g., the “rect_type”, a ratio of block width to block height and the block size may be used together to derive the context. As shown in the Table 2, block shape may be used to derive the context, for the ratio R of 1:1, the block sizes 8×8, 16×16, and 32×32 can be grouped together. For the ratio R of 1:2, the block shapes 8×16, 16×32, and 32×64 can be grouped together. For the ratio R of 2:1, the block shapes 16×8, 32×16 and 64×32 can be grouped together. For the ratio R of 1:4, the block shapes 8×32 and 16×64 can be grouped together. For the ratio R of 4:1, the block shapes 32×8 and 64×16 can be grouped together. Other block shapes with larger sizes have their own block size as the context.

In some embodiments, for square blocks, each different blocks size may have a different context. But for non-square rectangular blocks, the contexts may be grouped based on block size and block ratio. The context index derivation may consider the block shape ratio R and also the block size.

In some embodiments, the derivation of context, e.g., block shape context, also considers the neighboring (left and/or top blocks) blocks' partition context as described in Equation (1).

In some embodiments, the ratio of block width to height is combined with other factors to form the context for signaling, parsing and deriving the partition mode related syntax. The block size ratio may be combined with other information in the coding process, such as the plane type (luma or chroma), prediction type (intra or inter), and previous partition mode to determine the context of the current partition mode.

In some embodiments, the block shape of the neighboring blocks can also be used to derive the context for signaling the block partition related context of the current block. In some embodiments, the plane type (luma or chroma) can serve as the first dimension of the context derivation. The block shape may serve as the second dimension. For the ratio R of 1:1, the block sizes 8×8 and 16×16 can be grouped together. For the ratio R of 1:2, the block shapes 8×16 and 16×32 can be grouped together. For the ratio R of 2:1, the block shapes 16×8 and 32×16 can be grouped together. For the ratio R of 1:4, the block shapes 4×16, 8×32 and 16×64 can be grouped together. For the ratio R of 4:1, the block shapes 16×4, 32×8 and 64×16 can be grouped together. Other block shapes with large block sizes use their own block shape as the context.

In some embodiments, the first dimension is the plane type (luma or chroma), while the second dimension is the block shape, in relation to the partition context of neighboring blocks (top and/or left) as described in Equation (2).

In some embodiments, when the current block has a rectangular shape and the block width to height (or height to width) ratio N exceeds or is equal to a certain threshold T. The allowed partition split types at this partition point is a subset of the full partition modes. The subset of subsequent partition can be any combination of none partition, vertical partition, horizontal partition, H shape partition, and uneven 4-way partition, and the like. Then two syntax elements are required to indicate the partition subset index (sub_partition_set_flag) and the partition type index (sub_partition_type_flag) within the partition subset.

In some embodiments, T is set to 4. In some embodiments, when the current block has a rectangular shape and N exceeds a certain threshold, the subsequent partition set flag can be implicitly derived. In this case, only partition type index (sub_partition_type_flag) is required to be signaled. In some embodiments, when N exceeds the threshold, the subset size may be 1 and the subsequent partition is restricted to 1:k*N or k*N:1 for a current block shape of 1:N or N:1, respectively, as shown in FIG. 4B. In some embodiments, only a flag (sub_partition_flag) to indicate a following partition is required, the partition mode can be implicitly derived without signaling.

In some embodiments, when N exceeds the threshold, the subsequent partition is restricted to 1:2N or 2N:1 for a current block shape of 1:N or N:1, respectively, without the need for an explicit flag to indicate its partition mode in the bitstream. In some embodiments, only a flag (sub_partition_flag) is used to indicate whether the current block is split or not is required for the signaling, parsing, or deriving process. In some embodiments, when N exceeds the threshold, the subset size may be 1 and the subsequent partition block size is limited to 1:N/k or N/k:1 for a current block shape of 1:N or N:1, respectively, as shown in FIG. 2. In this case, only a flag to indicate following partition is required, the partition mode can be implicitly derived without signaling. In some embodiments, when N exceeds the threshold, the subsequent partition block size is limited to 1:N/2 or N/2:1 for a current block shape of 1:N or N:1, respectively, without the need for an explicit flag to indicate its partition mode. In some embodiments, only a flag is used to indicate whether the current block is split or not is required for the signaling, parsing, or deriving process. In some embodiments, when N exceeds the threshold, the subset size may be 1 and the subsequent partition block size is limited vert_H and horz_H for a current block shape of 1:N or N:1, respectively, or vice versa. In some embodiments, when N exceeds the threshold, the subset size may be 2 and the subsequent partition block size is limited to [vert_uneven_4way_A, vert_uneven_4way_B] and [hort_uneven_4way_A, hort_uneven_4way_B] for a current block shape of 1:N or N:1, respectively, or vice versa.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data (e.g., a source video sequence) comprising a plurality of blocks (e.g., corresponding to a set of pictures) that includes a current block. The system partitions (554) the current block according to a set of block partitioning parameters. The system entropy generates (556) a set of entropy-encoded syntax elements by: when a shape of the current block is a first shape, entropy encoding the set of block partitioning parameters using a first context; and when the shape of the current block is a second shape, different than the first shape, entropy encoding the set of block partitioning parameters using a second context, different than the first context. The system signals (558) the set of entropy-encoded syntax elements in a video bitstream. As described previously, the encoding process may mirror the decoding processes described herein (e.g., entropy decoding). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

In some embodiments, a context for rectangular partition type (e.g., “rect_type_cdf”) syntax is based on a shape of the coded block. The context derivation may be:

static INLINE int partition_plane_context (const MACROBLOCKD *xd, int mi_row, int
mi_col, BLOCK_SIZE bsize)
{const int ctx = (left_ctx * 2 + above_ctx) + rect_bsize_map[bsize] *
PARTITION_PLOFFSET; }

An example context grouping for the rectangular partition type syntax is shown in Table 9 below.

TABLE 9
Example Context Grouping

| CTX Index | Block Size |
|---|---|
| 0 | 4 × 4, 4 × 8, 8 × 4, |
| | 8 × 8, 16 × 16 |
| 1 | 8 × 16, 16 × 32 |
| 2 | 16 × 8, 32 × 16 |
| 3 | 32 × 32 |
| 4 | 32 × 64 |
| 5 | 64 × 32 |
| 6 | 64 × 64 |
| 7 | 64 × 128 |
| 8 | 128 × 64 |
| 9 | 128 × 128 |
| 10 | 128 × 256 |
| 11 | 256 × 128 |
| 12 | 256 × 256 |
| 13 | 4 × 16, 8 × 32, 16 × 64 |
| 14 | 16 × 4, 32 × 8, 64 × 16 |

In this way, the context size may be reduced from 2×25×4=200 to 2×15×4=120, and the memory may be reduced from 4000 bits to 2400 bits. For example, blocks that are 4×4, 4×8, and 8×4 size do not need rectangle partition signaling, and 1:8 and 1:16 ratio blocks cannot be partitioned further.

Simulation data on AVM v8 anchor for all-intra and random access configurations has shown that by grouping the context of rectangle partition type (“rect_type_cdf”) syntax element for reduction based on the shape of the coded block, results in 3% decoding time saving for All Intra mode, 1% decoding time saving and only 0.01% coding loss for Random Access mode, and 2% decoding time saving with 0.01% coding loss for Low Delay mode.
(A1) In one aspect, some embodiments include a method (e.g., the method 500) of video decoding. In some embodiments, the method is performed at a computing system (e.g., the server system 112) having memory and one or more processors. In some embodiments, the method is performed at a coding module (e.g., the coding module 320). The method includes: (i) receiving a video bitstream comprising a plurality of blocks including a current block, and a set of syntax elements related to block partitioning; when a shape of the current block is a first shape, (ii) entropy decoding the set of syntax elements using a first context; when the shape of the current block is a second shape, different than the first shape, (iii) entropy decoding the set of syntax elements using a second context, different than the first context; and (iv) partitioning the current block according to the set of syntax elements. For example, the shape of the current block may be employed to derive the context for the partition mode related syntaxes of the current block. In some embodiments, the method includes determining a shape of the current block (e.g., determining whether the current block has the first shape or the second shape). In some embodiments, in accordance with a determination that the current block has the first shape, the set of syntax elements are entropy decoded using the first context, and in accordance with a determination that the current block does not have the first shape, the set of syntax elements are entropy decoded without using the first context. In some embodiments, the method further comprises decoding the current block by decoding each partition of the current block (resulting from the partitioning).
(A2) In some embodiments of A1, the first context or second context is selected based on the shape of the current block and a size of the current block. For example, the ratio R of block width to block height may used as the context when signaling or parsing the partition mode related syntaxes. In some embodiments, the first context is selected using a look-up table. In some embodiments, an index to the look-up table is derived based on the shape and size of the current block. As an example, a context index derivation may consider the block shape ratio R and also the block size.
(A3) In some embodiments of A1 or A2, the first context or second context is selected using a look-up table and an index based on the shape of the current block. For example, the context for the current block may be selected using Table 2, Table 3, or Table 4. In some embodiments, potential shapes and sizes for the current block are grouped together in the look-up table. In some embodiments, smaller block sizes are grouped together (e.g., share a same context) and larger block sizes are ungrouped (e.g., have a unique context). In some embodiments, each size of square-shaped block has a unique context (e.g., and non-square-shaped blocks may share contexts). For example, the context for the current block may be selected using Table 5.
(A4) In some embodiments of any of A1-A3, the shape of the current block comprises a ratio of block height to block width for the current block. For example, the block shape can refer to a block-width-to-height ratio, a block area size, or whether block is square block, tall block, or flat block. In various examples, the ratio, R, may be 1:1, 1:2, 1:4, . . . , 1:N, and 2:1, 4:1, . . . , N:1.
(A5) In some embodiments of any of A1-A4, the first context or second context is selected based on the shape of the current block and a context of a neighboring block. For example, the derivation of context (e.g., block shape context) also considers the neighboring (left and/or top blocks) blocks' partition context. As a specific example, the context may be derived using Equation 1.
(A6) In some embodiments of any of A1-A5, the first context or second context is selected based on the shape of the current block and previously-decoded information. For example, the ratio of block width to height may be combined with other factors to form the context for signaling, parsing and deriving the partition-mode-related syntax. The previously-decoded information may comprise a plane type (e.g., luma or chroma), a prediction type (e.g., intra or inter), and/or a previous partition mode.
(A7) In some embodiments of A6, the previously-decoded information comprises a shape of a neighboring block of the current block. For example, the block shape of one or more neighboring blocks may also be used to derive the context for signaling the block partition related context of current block.
(A8) In some embodiments of A6 or A7, the previously-decoded information

comprises a plane type of the current block. For example, the plane type (e.g., luma or chroma) may be used as the first dimension of the context derivation, and the block shape may be used as the second dimension. In some embodiments, the plane type is used as a first dimension, and the block shape is used as a second dimension relative to a context of a neighboring block. For example, the context may be derived using Equation 2.
(A9) In some embodiments of any of A1-A8, the method further includes, when a ratio of block height to block width for the current block meets one or more criteria, restricting available partition modes for the current block to a subset of available partition modes. For example, when the current block has a rectangular shape and the block width to height (or height to width) ratio N exceeds, or optionally is equal to, a certain threshold T, the allowed partition split types at this partition point may be a subset of the full partition modes.
(A10) In some embodiments of any of A1-A9, the set of syntax elements comprises one or more of: a first syntax element indicating whether the current block is to be partitioned; a second syntax element indicating whether the current block is to be partitioned into four square blocks; a third syntax element indicating whether the current block is to be partitioned in a horizontal or vertical mode; a fourth syntax element indicating whether the current block is to be partitioned with an extension partition; a fifth syntax element indicating whether the current block is to be partitioned with an uneven 4-way partition; and a sixth syntax element indicating a type of uneven 4-way partition for the current block.
(B1) In another aspect, some embodiments include a method (e.g., the method 550) of video encoding. In some embodiments, the method is performed at a computing system (e.g., the server system 112) having memory and one or more processors. In some embodiments, the method is performed at a coding module (e.g., the coding module 320). The method includes: (i) receiving video data comprising a plurality of blocks that includes a current block; (ii) partitioning the current block according to a set of block partitioning parameters; (iii) generating a set of entropy-encoded syntax elements by: when a shape of the current block is a first shape, entropy encoding the set of block partitioning parameters using a first context; and when the shape of the current block is a second shape, different than the first shape, entropy encoding the set of block partitioning parameters using a second context, different than the first context; and (iv) signaling the set of entropy-encoded syntax elements in a video bitstream. In some embodiments, the partitioned blocks of the current block are encoded and signaled in the video bitstream.
(B2) In some embodiments of B1, the first context or second context is selected based on the shape of the current block and coding information relating to the current block.
(B3) In some embodiments of B2, the coding information comprises a size of the current block.
(B4) In some embodiments of B2 or B3, the coding information comprises a plane type of the current block.
(B5) In some embodiments of any of B2-B4, the coding information comprises a shape of a neighboring block of the current block.
(B6) In some embodiments of any of B1-B5, the shape of the current block comprises a ratio of block height to block width for the current block.
(B7) In some embodiments of any of B1-B6, the first context or second context is selected using a look-up table and an index based on the shape of the current block.
(C1) In another aspect, some embodiments include a method of visual media data processing. In some embodiments, the method is performed at a computing system (e.g., the server system 112) having memory and one or more processors. In some embodiments, the method is performed at a coding module (e.g., the coding module 320). The method includes: (i) obtaining a source video sequence that comprises a plurality of frames; and (ii) performing a conversion between the source video sequence and a video bitstream of visual media data according to a format rule. The video bitstream comprises a plurality of encoded blocks including a current block, and a set of syntax elements related to block partitioning; and the format rule specifies that: when a shape of the current block is a first shape, the set of syntax elements is to be entropy decoded using a first context; when the shape of the current block is a second shape, different than the first shape, the set of syntax elements is to be entropy decoded using a second context, different than the first context; and the current block is to be partitioned according to the set of syntax elements.
(C2) In some embodiments of C1, the first context or second context is selected based on the shape of the current block and coding information relating to the current block.
(C3) In some embodiments of C1 or C2, the set of entropy-encoded syntax elements comprises one or more of: a first syntax element indicating whether the current block is to be partitioned; a second syntax element indicating whether the current block is to be partitioned into four square blocks; a third syntax element indicating whether the current block is to be partitioned in a horizontal or vertical mode; a fourth syntax element indicating whether the current block is to be partitioned with an extension partition; a fifth syntax element indicating whether the current block is to be partitioned with an uneven 4-way partition; and a sixth syntax element indicating a type of uneven 4-way partition for the current block.
(D1) In one aspect, some embodiments include a method (e.g., the method 600) of video decoding. In some embodiments, the method is performed at a computing system (e.g., the server system 112) having memory and one or more processors. In some embodiments, the method is performed at a coding module (e.g., the coding module 320). The method includes: (i) receiving a video bitstream comprising a plurality of blocks including a current block; when an aspect ratio of the current block meets one or more criteria, (ii) partitioning the current block using a first partitioning mode from a first set of partitioning modes; and when the aspect ratio of the current block does not meet the one or more criteria, (iii) partitioning the current block using a second partitioning mode from a second set of partitioning modes. The second set of partitioning modes is a subset of the first set of partitioning modes. For example, when the current block has a rectangular shape and the block width to height (or height to width) ratio N exceeds, or optionally is equal to, a certain threshold T, the allowed partition split types at this partition point may be a subset of the full partition modes.
(D2) In some embodiments of D1, the second set of partitioning modes consists of one or more of: a none partition; a vertical partition; a horizontal partition; an H-shape partition; and an uneven 4-way partition.
(D3) In some embodiments of D1 or D2, the one or more criteria comprises a criterion that the aspect ratio of the current block is greater than a preset threshold. For example, the preset threshold may be 4.
(D4) In some embodiments of any of D1-D3, the method further comprises, when the aspect ratio of the current block does not meet the one or more criteria, identifying the second partitioning mode based on one or more syntax elements signaled in the video bitstream.
(D5) In some embodiments of D4, the one or more syntax elements comprise a first syntax element indicating the second set of partitioning modes and a second syntax element indicating a partition type within the second set of partitioning modes. For example, two syntax elements may be used to indicate the partition subset index (e.g., sub_partition_set_flag) and the partition type index (e.g., sub_partition_type_flag) within the partition subset (e.g., as shown in Table 6).
(D6) In some embodiments of any of D1-D5, the method further comprises deriving the second set of partitioning modes, wherein the one or more syntax elements comprise a syntax element indicating a partition type within the second set of partitioning modes. For example, when the current block has a rectangular shape and N exceeds a certain threshold, the subsequent partition set flag may be implicitly derived. In this example, only a partition type index (e.g., sub_partition_type_flag) is signaled (e.g., as shown in Table 7).
(D7) In some embodiments of any of D1-D6, the second set of partitioning modes consists of one partitioning mode. For example, when N exceeds a threshold, the subset size may be 1 (e.g., the subsequent partition is restricted to 1:k*N or k*N:1 for a current block shape of 1:N or N:1, respectively (e.g., as illustrated in FIG. 4B)). In this example, only a flag (sub_partition_flag) to indicate following partition may be signaled, as the partition mode can be implicitly derived without signaling. As another example, when N exceeds the threshold, the subset size may be 1 (e.g., the subsequent partition block size is limited to 1:N/k or N/k:1 for a current block shape of 1:N or N:1, respectively (e.g., as illustrated in FIG. 4C)). In some embodiments, k is a constant integer (e.g., equal to 2, 3, or 4).
(D8) In some embodiments of D7, the one partitioning mode is a vertical mode when the aspect ratio of the current block is 1:N, and wherein the one partitioning mode is horizontal mode when the aspect ratio of the current block is N:1. For example, when N exceeds the threshold, the subset size may be 1 and the subsequent partition block size is limited vert_H and horz_H for a current block shape of 1:N or N:1, respectively, or vice versa.
(D9) In some embodiments of any of D1-D6, the second set of partitioning modes consists of two partitioning modes.
(D10) In some embodiments of D9, the two partitioning modes are vertical modes when the aspect ratio of the current block is 1:N, and wherein the two partitioning modes are horizontal modes when the aspect ratio of the current block is N:1. For example, when N exceeds the threshold, the subset size may be 2 and the subsequent partition block size is limited to [vert_uneven_4way_A, vert_uneven_4way_B] and [hort_uneven_4way_A, hort_uneven_4way_B] for a current block shape of 1:N or N:1, respectively, or vice versa.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A10, B1-B7, C1-C3, and D1-D10 above). In yet another aspect, some embodiments include a non-transitory computer-readable storage medium storing one or more sets of instructions for execution by control circuitry of a computing system, the one or more sets of instructions including instructions for performing any of the methods described herein (e.g., A1-A10, B1-B7, C1-C3, and D1-D10 above).

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context. As used herein, N refers to a variable number. Unless explicitly stated, different instances of N may refer to the same number (e.g., the same integer value, such as the number 2) or different numbers.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks including a current block, and a set of syntax elements related to block partitioning;
when a shape of the current block is a first shape, entropy decoding the set of syntax elements using a first context;
when the shape of the current block is a second shape, different than the first shape, entropy decoding the set of syntax elements using a second context, different than the first context; and
partitioning the current block according to the set of syntax elements.

2. The method of claim 1, wherein the first context or second context is selected based on the shape of the current block and a size of the current block.

3. The method of claim 1, wherein the first context or second context is selected using a look-up table and an index based on the shape of the current block.

4. The method of claim 1, wherein the shape of the current block comprises a ratio of block height to block width for the current block.

5. The method of claim 1, wherein the first context or second context is selected based on the shape of the current block and a context of a neighboring block.

6. The method of claim 1, wherein the first context or second context is selected based on the shape of the current block and previously-decoded information.

7. The method of claim 6, wherein the previously-decoded information comprises a shape of a neighboring block of the current block.

8. The method of claim 6, wherein the previously-decoded information comprises a plane type of the current block.

9. The method of claim 1, further comprising, when a ratio of block height to block width for the current block meets one or more criteria, restricting available partition modes for the current block to a subset of available partition modes.

10. The method of claim 1, wherein the set of syntax elements comprises one or more of:
a first syntax element indicating whether the current block is to be partitioned;
a second syntax element indicating whether the current block is to be partitioned into four square blocks;
a third syntax element indicating whether the current block is to be partitioned in a horizontal or vertical mode;
a fourth syntax element indicating whether the current block is to be partitioned with an extension partition;
a fifth syntax element indicating whether the current block is to be partitioned with an uneven 4-way partition; and
a sixth syntax element indicating a type of uneven 4-way partition for the current block.

11. A method of video encoding performed at a computing system having memory and one or more processors, the method comprising:
receiving video data comprising a plurality of blocks that includes a current block;
partitioning the current block according to a set of block partitioning parameters;
generating a set of entropy-encoded syntax elements by:
when a shape of the current block is a first shape, entropy encoding the set of block partitioning parameters using a first context; and
when the shape of the current block is a second shape, different than the first shape, entropy encoding the set of block partitioning parameters using a second context, different than the first context; and
signaling the set of entropy-encoded syntax elements in a video bitstream.

12. The method of claim 11, wherein the first context or second context is selected based on the shape of the current block and coding information relating to the current block.

13. The method of claim 12, wherein the coding information comprises a size of the current block.

14. The method of claim 12, wherein the coding information comprises a plane type of the current block.

15. The method of claim 12, wherein the coding information comprises a shape of a neighboring block of the current block.

16. The method of claim 11, wherein the shape of the current block comprises a ratio of block height to block width for the current block.

17. The method of claim 11, wherein the first context or second context is selected using a look-up table and an index based on the shape of the current block.

18. A non-transitory computer-readable storage medium storing a video bitstream that is generated by a video encoding method, the video encoding method comprising:
receiving video data comprising a plurality of blocks that includes a current block;
partitioning the current block according to a set of block partitioning parameters; and
generating a set of entropy-encoded syntax elements by:
when a shape of the current block is a first shape, entropy encoding the set of block partitioning parameters using a first context; and
when the shape of the current block is a second shape, different than the first shape, entropy encoding the set of block partitioning parameters using a second context, different than the first context; and
wherein the video bitstream comprises the set of entropy-encoded syntax elements.

19. The non-transitory computer-readable storage medium of claim 18, wherein the first context or second context is selected based on the shape of the current block and coding information relating to the current block.

20. The non-transitory computer-readable storage medium of claim 18, wherein the set of entropy-encoded syntax elements comprises one or more of:
a first syntax element indicating whether the current block is to be partitioned;
a second syntax element indicating whether the current block is to be partitioned into four square blocks;
a third syntax element indicating whether the current block is to be partitioned in a horizontal or vertical mode;
a fourth syntax element indicating whether the current block is to be partitioned with an extension partition;
a fifth syntax element indicating whether the current block is to be partitioned with an uneven 4-way partition; and
a sixth syntax element indicating a type of uneven 4-way partition for the current block.
